(19) United States
(12) Patent Application Publication
(10) Pub. No.: US 2009/0099962 A1
(43) Pub. Date: Apr. 16, 2009

(54) APPARATUS AND METHODS FOR FACILITATING CARBON CREDITS

(76) Inventors: Mark L. GREEN, St. Louis, MO (US); Chris CARL, Kirkwood, MO (US)

Correspondence Address: HARNESS, DICKEY, & PIERCE, P.L.C, 7700 Bonhomme, Suite 400, ST. LOUIS, MO, 63105, US

(21) Appl. No.: 11/872,539

(22) Filed: Oct. 15, 2007

(51) Int. Cl. G06Q 40/00

(52) U.S. Cl. 705/39; 702/28

(57) ABSTRACT

A processor-performed method of facilitating the creation and sale of carbon credits. The method includes enrolling a plurality of carbon credits in a database. Each credit is associated with an account of a creator of the credit and with a project for generating the credit. The method includes determining whether one of the one or more projects is registered in a climate action registry; and, based on the determining, registering in the registry a validated credit associated with the registered project and including the registered credit in an account of an aggregator.

### FIELD

The present disclosure relates to facilitating the establishment, use and/or trading of carbon credits by producers, aggregators, registries, exchanges and/or purchasers.

### BACKGROUND

The statements in this section merely provide background information related to the present disclosure and may not constitute prior art.

Carbon credits have come into use as financial derivatives to encourage the reduction of emissions of carbon dioxide (CO2) and other greenhouse gases into the atmosphere. Property owners who can show verifiable reduction in CO2 emissions can qualify for carbon credits, Markets have been forming for the trading of carbon credits, and methodologies for the management of carbon credit trading are still being developed.

### SUMMARY

The present disclosure, in one implementation, is directed to a processor-performed method of facilitating the creation and sale of carbon credits. The method includes enrolling a plurality of carbon credits in a database. Each credit is associated with an account of a creator of the credit and with a project for generating the credit. The method includes determining whether one of the one or more projects is registered in a climate action registry; and, based on the determining, registering in the registry a validated credit associated with the registered project and including the registered credit in an account of an aggregator.

In another implementation, the disclosure is directed to a system for facilitating the creation and sale of carbon credits. The system includes at least one processor and memory configured to enroll a plurality of carbon credits in a database, and, for each credit, to associate the credit with an account of a creator of the credit and with a project for generating the credit. The processor(s) and memory are configured to determine whether one of the project(s) is registered in a climate action registry, and based on the determining, allow an aggregator to access, via a network and based on the project registration, data pertaining to at least one credit associated with the registered project.

In yet another implementation, the disclosure is directed to a system for facilitating the creation and sale of carbon credits. At least one processor and memory are configured to enroll a plurality of carbon credits in a database, and for each credit, associate the credit with an account of a creator of the credit and with a project for generating the credit. At least one satellite is configured to provide multi-spectral imagery of a location of one of the project(s). The processor(s) and memory are further configured to use the imagery to determine a quantity of biomass at the location, and to use the determined biomass quantity to verify whether at least one of the credits is an actual credit.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flow diagram of a method of facilitating the creation and sale of carbon credits in accordance with one implementation of the disclosure;

FIG. 2 is a block diagram of a system for facilitating the creation and sale of carbon credits in accordance with one implementation of the disclosure; and

FIG. 3 is a flow diagram of a business process flow in accordance with one implementation of the disclosure.

### DETAILED DESCRIPTION

The following description is merely exemplary in nature and is not intended to limit the present disclosure, application, or uses.

The present disclosure, in various implementations, is directed to a system that allows real property owners to create carbon credits from farming and/or other land-based operations. The credits may be validated for purchase, e.g., by an aggregator or an exchange. Credits may also be registered, e.g., in a climate action registry. It should be noted generally that, unless otherwise indicated, the term “carbon credit” is used in this disclosure and the claims to refer generally to a carbon offset amount that may vary from offset to offset. The term “carbon credit” may also at times be used herein to refer to a credit for a predefined tonnage amount, e.g., for one carbon ton.

Various implementations of the disclosure provide for conversion of output of green energy producing systems to carbon credits. Various implementations can provide a system of record for property owners, aggregators, registries, exchanges and buyers of carbon credits. It should be understood, however, that although various implementations of the disclosure may be discussed with reference to carbon credits in relation to farming operations, the disclosure is not so limited. The disclosure could be implemented in connection with creation of carbon credits in virtually any environment. Further, carbon credits might be created in more than one way in a particular geographic location. Therefore it is contemplated in various implementations that a given land parcel would not necessarily be limited to the production of a single carbon credit at any one time.

Additionally, although reference is made herein to registries, aggregators and exchanges, it should be understood that in some instances the terms may be interchangeable. An aggregator is typically an intermediary between carbon credit producers and an exchange. An aggregator may pool carbon credits into one or more blocks for purposes of trading the credits on an exchange. In various implementations, however, behavior of a system in accordance with the disclosure with respect to an aggregator may be the same as or similar to behavior of that system relative to an exchange. Accordingly, unless otherwise indicated, references to an “aggregator” may be construed to refer to or include an exchange, and vice-versa. The terms “climate action registry” and “registry” may be used to refer to an emissions and/or offset registry, a project registry, an exchange registry, etc. The term may include but is not limited to a registry established in order to promote coherency, value and integrity in carbon credit market transactions. Such registries may be maintained, used and/or referred to by, e.g., owners, aggregators, exchanges, regulators and/or purchasers of carbon credits.

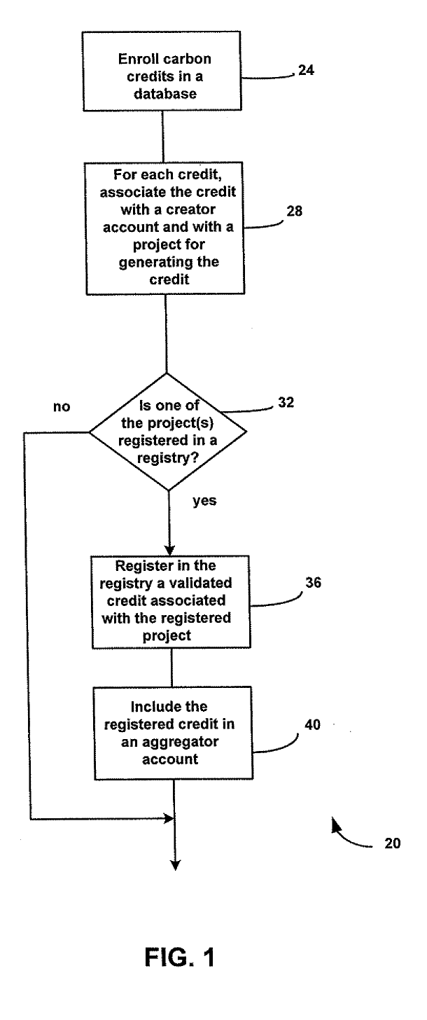

A method of facilitating the creation and sale of carbon credits is indicated generally in FIG. 1 by reference number 20. The method 20 may be performed by one or more processors. In step 24, a plurality of carbon credits are enrolled in a database. In step 28, each of the credits is associated with an account of a creator of the credit and with a project for generating the credit. In step 32, it is determined whether a given one of the project(s) is registered in a climate action registry. Such registries may include, e.g., the California Climate Action Registry, at wwwclimateregistry.org, the Regional Greenhouse Gas Initiative (RGGI) at www.rqqi.orq, and the International Transaction Log (ITL) of the United Nations Framework Convention on Climate Change (UNFCCC). If the given project is registered, then in step 36 a validated credit associated with the registered project is registered in the registry. In step 40, the registered credit is included in an account of an aggregator.

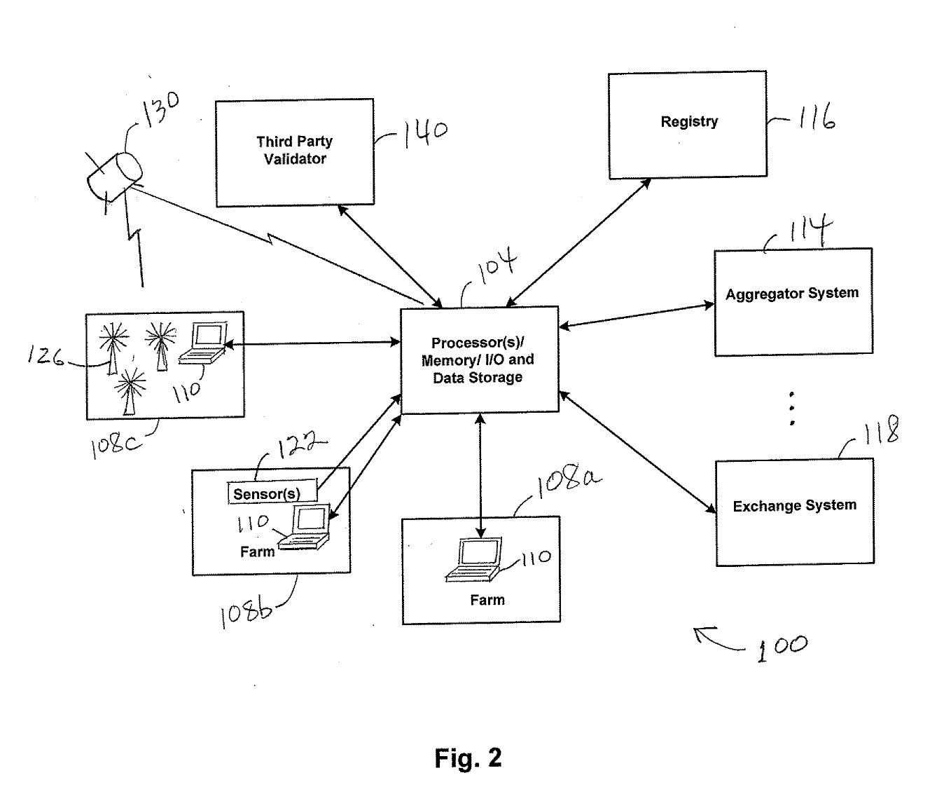

A system for facilitating the creation and sale of carbon credits in one implementation of the disclosure is indicated generally in FIG. 2 by reference number 100. The system 100 includes one or more processors, memory, data storage and input/output ports/device(s), indicated collectively in FIG. 2 by reference number 104 and referred to as computer 104. It should be understood that the computer 104 could have many different configurations and could include components different from and/or in addition to those shown in FIG. 2. Further, the computer 104 could include components distributed in one or more locations remote from other computer 104 component(s). Still further, there could be more than one computer 104 in some configurations. In various implementations the computer 104 includes one or more gateways to a network, e.g., the Internet.

The computer 104 receives data pertaining to a plurality of carbon credit creators, e.g., property owners who establish one or more projects on their land by which carbon credits may be obtainable. Such projects may include but are not limited to reforestation projects, wind turbine projects, no-till projects, methane recovery, etc. As for the exemplary system shown in FIG. 2, property owners include, e.g., farmers of one or more farms 108 (three farms 108a, 108b and 108c being shown in FIG. 2). The farmers may transmit data via their computers 110 to the computer 104. The computer 104 also may communicate with one or more carbon credit aggregator systems 114 and with one or more climate action registries 116. An aggregator system 114 may communicate with one or more exchange systems 118, at least some of which may also communicate with the computer 104. It should be understood that the system 100 is flexible as to what type of entities may be in communication with or through the system. In some configurations, for example, an aggregator system and/or exchange system may communicate with one or more registries 116 through and/or outside the system 100.

The computer 104 enrolls a plurality of potential and/or actual carbon credits in the system 100 based on the data received from the farmers. After a carbon credit is enrolled, the system 100 tracks a plurality of statuses for the enrolled credit as further described below. The system 100 may perform the tracking until after the enrolled credit has been sold. The system 100 gathers data relevant to actualization of a potential credit and analyzes the gathered data to verify whether the potential credit has become an actual credit. The system 100 also provides access to the tracked statuses for a given credit to one or more of the following: a creator of the given credit, an aggregator of the given credit, and an exchange.

As mentioned above, the system 100 tracks a plurality of statuses of an enrolled carbon credit. Thus, for example, a credit creator and/or aggregator may check on a verification status of a credit. That is, the creator and/or aggregator may query the system 100 to determine whether the system 100 has verified that a potential credit has become an actual credit. In some implementations, if a potential credit has not yet developed into an actual credit, the creator and/or aggregator may determine from the system 100 how far along the credit may be in the actualization process. Other status information in the system 100 available to a credit creator and/or accumulator with respect to a given carbon credit may include, but is not necessarily limited to, ownership, validation status, pooling status, and valuation status.

In various implementations, enrolled carbon credits are searchable by aggregators, e.g., who seek to purchase specific kinds of carbon credits. This capability provides aggregators with flexibility as to what types of carbon credits they may purchase. The system 100 provides a web-based registration point for enrollment of carbon credits, not only by property owners and/or other carbon credit creators, but also by carbon credit aggregators. Thus aggregators may enroll their carbon inventories in the system 100. Further, a farmer and/or other carbon credit creator could enroll in the system 100 a credit already included in a pre-existing inventory of an aggregator.

Carbon credits enrolled in the system 100 may be associated with a plurality of methods of credit creation. For example, a farmer of the farm 108a may wish to set up a no-till project, specifically, to obtain a carbon credit by using no-till procedures on a specific parcel of land on the farm 108a. Accordingly, the farmer of the farm 108a sends information to the system 100 useful for locating and identifying the parcel. The system 100 associates the parcel with an enrolled carbon credit as further described below. A farmer of the farm 108b may wish to obtain a carbon credit by using methane recovery procedures. Accordingly, the farmer of the farm 108b registers with the system 100 a property address where the methane recovery is to take place. The farmer also may install methane and/or other sensors 122 for communication with the system 100 and by which the system 100 may monitor the recovery procedure. A farmer of the farm 108c may wish to obtain carbon offsets through use of a plurality of wind turbines 126 on the farm 108c. Accordingly, the farmer of the farm 108c uses his/her computer 110 to send data via the Internet to the computer 104 descriptive of the turbines, including, e.g., their locations, their power rating, etc. The system 100 thus may be used in connection with the creation and sale of a plurality of types of carbon credits, including but not limited to credits created through conservation tillage/carbon sequestration, nutrient management, methane recovery, biotechnology, bio control, nitrogen neutralization, bio fuels, natural gas avoidance monitoring within ethanol, reforestation, etc.

In addition to or instead of gathering data from sensors 122, the system 100 may gather data in a plurality of other or additional ways to verify whether a potential credit has become an actual credit. For example, a satellite 130 may be used to monitor wind turbines 126, e.g., by acquiring imagery confirming the existence, location(s) and operational status of the turbines. The satellite 130 transmits the monitoring data to the computer 104, which is configured to provide verification as to the status of the turbines.

The satellite 130 may be used to monitor the development of other or additional enrolled carbon credits. For example, the satellite 130 may be used to monitor no-till usage of land on the farm 108a in connection with an enrolled carbon credit. In some implementations, one or more satellites 130 may be used to gather multi-spectral imagery for monitoring carbon credit development at a location included in a project for carbon credit creation.

The computer 104 may receive and analyze multi-spectral images of the location to determine whether land characteristics are present that indicate whether and/or how far a carbon credit creation project has progressed. For example, images may be analyzed with reference to the infrared (IR) band to determine whether and/or to what extent biomass is present in the location. Presence and/or extent of biomass can be indicative of crop residue and accordingly can indicate adherence to no-till procedures at that location.

Multi-spectral imagery analysis may be performed in connection with other or additional types of carbon credit creation. For example, infrared analysis could also be used to determine whether forestry methods are being used effectively for carbon credit creation. Imagery analysis could also include variation analysis with regard to land characteristics, in order to quantify carbon offset amounts for which carbon credits may be issued. For example, such analysis may be used to determine depth(s) of biomass in a land parcel included in a no-till or forestry project. A carbon offset tonnage amount may be established based on the biomass depth(s).

A satellite 130 may pass over and image a location periodically, e.g., between periods of from about 3 to about 7 days. Image resolution may be, e.g., at about 25 meters. Imagery may be provided by public and/or private satellite imagery providers. Infrared analysis could be performed, e.g., on a weekly to monthly basis to verify whether a location is generating carbon credit(s).

It should be understood that “sensor” is used broadly to refer to and include a wide variety of devices. Such devices may include, e.g., inverters that may be connected in an electrical system to sense energy use, other kinds of energy sensors, temperature sensors, usage meters, light sensors, wind speed and/or direction sensors, motion detectors, heat sensors, water sensors, emission sensors, analog and digital signal receivers, cameras, satellites (e.g., the satellite 130), etc. Reference is made to various systems and methods for facilitating environmental resource and/or energy management on farms, described in co-pending U.S. patent application Ser. No. 11/707,847, entitled “Facilitating Environmental Resource and/or Energy Management on Farms”, filed on Feb. 16, 2007, and to U.S. patent application Ser. No. 11/760,577, entitled “Facilitating Creation and Sale of Carbon Credits”, filed Jun. 8, 2007, the disclosures of which are incorporated herein by reference in their entirety.

In addition to (or in some cases, instead of) receiving sensor information, the computer 104 may receive data from a farmer and/or other party affiliated with a farm 108. For example, farmers of the farms 108a, 108b and 108c may use computers 110 to communicate with the computer 104 via the Internet or other network. It also is contemplated that a farmer could convey information to the computer 104 in other ways, for example, by telephone, cell phone, etc. In some implementations, a farmer could convey voice information that would be transcribed into digital form for input to the computer 104.

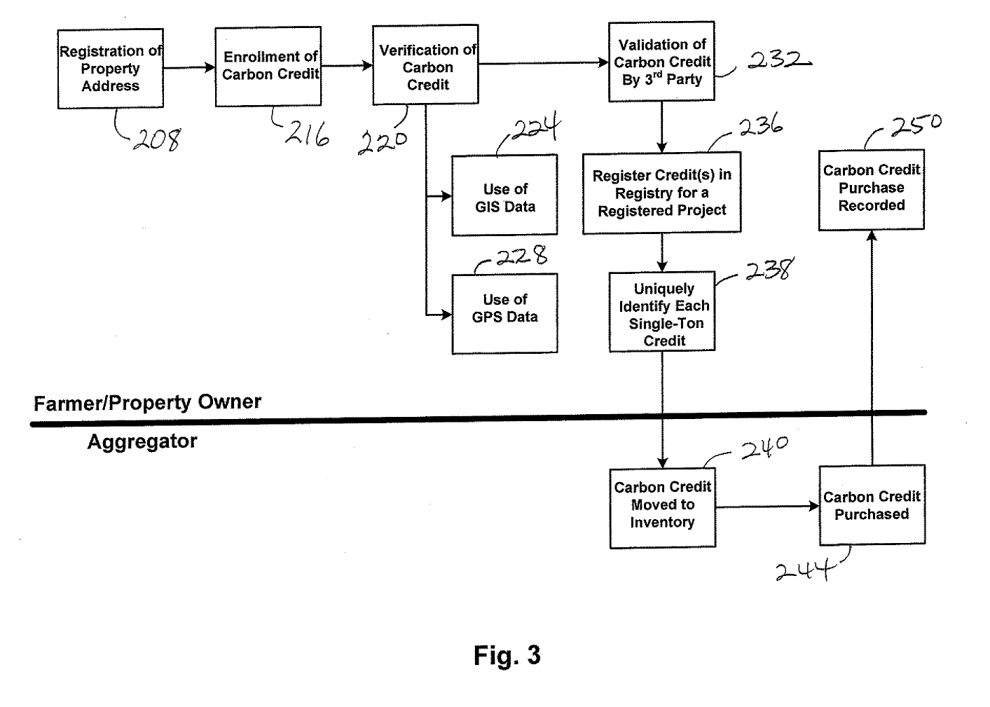

An exemplary business process flow is indicated generally in FIG. 3 by reference number 200. In step 208, a farmer, property owner or other carbon credit creator registers a property address with the system 100 in an account of the creator. In step 216, the creator enrolls an actual or potential carbon credit in the system 100. In step 220, the system 100 verifies a development status of the credit. In the present example, to perform verification, the system 100 in step 224 uses GIS data and in step 228 uses GPS data. The verification status is made available to the credit creator in the account of the creator.

When the credit is verified by the system 100 as being an actual credit, in step 232, and referring also to FIG. 2, the actualization of the credit is validated by an independent third party 140. An independent third party may be, e.g., an organization that physically locates a property associated with the credit and determines whether the credit was actually produced. The third party may record specific details in the system 100 with reference to validation of a carbon credit.

When a carbon credit is indicated in the system 100 as having been validated, the system 100 determines whether the credit is associated with a carbon creation project registered in a registry 116. If the credit is for a registered project, then in step 236 the system 100 provides information as to the validation to the appropriate registry 116 so that the validation is recorded in the register 116 relative to its carbon credit creation project.

It should be noted that registration of the credit in a registry 116 can serve to apportion, or assist in apportioning, the validated carbon tonnage offset of the credit. For example, the credit may be “serialized”, e.g., into single-ton credits. In such manner, each carbon ton of the credit may be assigned a unique identifier, in the registry 116 and/or in the system 100, in association with the registered project in which the credit has been generated. Where a registry 116 serializes and/or provides unique serialization identifiers, the system 100 extracts and uses the identifiers from the registry 116. If no registry 116 identifiers are available, the system 100 may perform serialization to uniquely identify single-ton credits.

In step 328 the system 100 incorporates the tonnage identifier(s) for each registered credit with a system 100 identifier for that credit. Each ton registered in a registry 116 thus is uniquely identified in the system 100, not only by a system 100 tonnage identifier but also by its project registration in a registry 116. Thus a given single-carbon-ton credit is prevented from being registered more than once in the system 100. The unique identifier for a single-ton credit remains in the system 100 over the life cycle of the credit. In such manner, for example, a prospective buyer of credits can compare a registry 116 registration of carbon tonnage offset by a given credit creation project with tonnage credits associated with that project in the system 100.

Credit validation and (if applicable) credit registration information is made available through the system 100 to the creator and to an aggregator, e.g., who may search the system 100 for such a credit. Unique identifiers for single-carbon-ton credits can be queried upon and viewed in the system 100, e.g., by aggregators seeking single-carbon-ton credits for their inventories. In step 240 the aggregator includes a validated credit in its inventory pool. In step 244 the credit is purchased by a purchaser through the aggregator. In step 250 the purchase is recorded in the system 100, in the account of the creator. In some implementations, purchases of carbon credits from the creator may be made by an aggregator or by an exchange. Such purchases also are recorded in the system 100, in the account of the creator.

The system 100 may register a farmer or other carbon credit creator based on a property address. Enrollment of a carbon credit may be based on property address, land parcel description, and/or other identifier that would relate the credit to the registrant. For a carbon credit, e.g., a no-till credit, that is defined with reference to a land parcel description and/or size, the system 100 maintains such information. The system 100 may verify reductions of carbon emissions, for example, by using the Geographic Information System (GIS) and/or Geographic Positioning System (GPS). A carbon credit may be located by gathering and organizing land-related information and by associating that information with the property address and/or GPS coordinates. The system 100 may map the property and/or divide it into agricultural field zones. A property address and/or zones may be defined by longitude/latitude data and/or GPS coordinates. The system 100 may use GIS data layers on top of aerial views of the property and compare multiple data points to verify carbon related information. A GIS record may be created with respect to each agricultural field zone, and fields of relevant agronomic information for that management zone are associated with the record. GIS records associated with the system 100 can be useful in verifying carbon credits. Additionally, means used to gather information for the GIS records can be useful for accumulating carbon credits.

The system 100 uses web services to integrate with registries 116. The system 100 also uses web services to integrate with aggregator systems 114 and/or exchange systems 118, which may access carbon credit inventory enrolled by aggregators and/or exchanges in the system 100. The system 100 may record carbon trade transaction data from aggregators and/or trading exchanges for carbon ton registered. The system 100 maintains data for a specific carbon credit throughout the life cycle of the carbon credit, e.g., from registration and enrollment, through a purchase of the credit, and through recordation of the purchase transaction in the system 100. The system 100 provides a plurality of search criteria that may be used, e.g., by aggregators and/or exchanges to identify specific types of carbon credits. Thus an aggregator may use purchase-specific criteria to search carbon credit inventory, e.g., where a state utility may want to purchase specific carbon credits from a particular state. A carbon credit creator may enroll a potential credit in the system 100 based on a previously enrolled credit that has been verified and/or validated. The system 100 can confirm and re-register land-based carbon credits, e.g., annually. Credit re-registration in the system 100 may take place automatically. Livestock-based credits, e.g., credits for methane burn-off projects, may be issued on a per-project basis.

The foregoing systems and methods allow carbon credits to be registered from clean energy technologies through the monitoring of amounts of clean energy produced, at the levels at which they are produced. A “clean energy” technology can be monitored, e.g., by an inverter local to the technology install, to monitor how much clean energy is produced and thus how much CO2 is offset. Farmers, property owners and other carbon creators are able to re-register carbon credit(s) based on their previous carbon credit transactions.

A carbon inventory management system can be provided by which aggregators can view and purchase validated carbon credits. Aggregators can enroll farmers or property owners in the foregoing system in order to register the aggregators' carbon credit inventory. Integration of the foregoing system with climate action and/or other registries makes it possible and convenient to prevent multiple registrations of a single credit. Accumulators and exchanges are also able to obtain information through the system for single-ton credits created in a given project registered in a given registry.

The foregoing systems and methods make it possible to streamline virtually all operations for a carbon credit to the point it becomes a financial commodity in an exchange system. Farmers and other would-be creators of carbon credits can be enabled to register, validate, verify and sell carbon credits and thereby take advantage of the emerging carbon credit market. Although carbon credit transactions typically have been complex, manual and time intensive, farmers can now create value from their current operations. Furthermore, a farmer or property owner can adopt farming best practices which lead to carbon credits issuance and an additional revenue stream.

What is claimed is:

1. A method of facilitating the creation and sale of carbon credits, the method performed by at least one computer having a processor and memory and configured for communication with one or more climate action registries and with one or more aggregator systems, the method comprising:
executing instructions to cause a plurality of carbon credits to be enrolled in a database;
for each credit, executing instructions to cause the credit to be associated with an account of a creator of the credit and with a carbon credit creation project for generating one or more environmental conditions for creating the credit;
executing instructions to determine whether one of the one or more carbon credit creation projects is registered in one of the one or more climate action registries and based on the determining, executing instructions to cause to be registered in the one of the one or more climate action registries a credit associated with the registered carbon credit creation project and validated by a third-party validator as having been created, and to make the validated and registered credit available to an aggregator in an account of the aggregator.

2. The method of claim 1, further comprising:
the at least one computer obtaining from the registry a registry identifier for the registered credit; and
the at least one computer using at least the registry identifier to uniquely identify the registered credit.

3. The method of claim 1, further comprising the at least one computer tracking a status of a credit to verify the credit.

4. The method of claim 3, wherein the tracking is performed using infrared satellite imagery analysis.

5. The method of claim 1, wherein the registered project is associated with the registry in the database.

6. A system for facilitating the creation and sale of carbon credits, the system comprising at least one processor and memory configured to:
enroll a plurality of carbon credits in a database;
for each credit, associate the credit with an account of a creator of the credit and with a carbon credit creation project for generating one or more environmental conditions for creating the credit;
determine whether one of the one or more carbon credit creation projects is registered in a climate action registry; and
based on the determining, allow an aggregator to access, via a network and based on the project registration, data pertaining to at least one credit associated with the registered project.

7. The system of claim 6, wherein the at least one processor and memory are configured to associate the registry with each credit associated with the registered project.

8. The system of claim 6, wherein the at least one processor and memory are configured to:
determine whether a credit associated with the registered project is validated; and
based on the determining, register the validated credit in the registry.

9. The system of claim 8, wherein the at least one processor and memory are further configured to provide the aggregator with a unique identifier for accessing data pertaining to the registered credit.

10. The system of claim 6, wherein the at least one processor and memory are further configured to receive, from at least one satellite, multi-spectral imagery of a location of one of the one or more projects, the at least one processor and memory further configured to use the imagery to determine a quantity of biomass at the location.

11. The system of claim 10, wherein the at least one processor and memory are further configured to use a determined biomass amount to verify that the potential credit has become an actual credit.

12. The system of claim 6, wherein the at least one processor and memory are further configured to:
track a status of a potential credit to verify the potential credit as an actual credit;
determine whether the actual credit is associated with a carbon creation project registered in the registry; and, based on the determining:
allow the aggregator to access data pertaining to the actual credit based on the registry association.

13. The system of claim 12, wherein the tracking is performed using infrared satellite imagery analysis.

14. The system of claim 6, wherein the at least one processor and memory are further configured to:
determine whether one or more of a plurality of potential credits associated with a project registered in a climate action registry have become one or more actual credits;
based on the determining and on whether one or more potential credits are validated, identify each actual credit to the registry.

15. The system of claim 6, wherein the at least one processor and memory are configured to serialize one of the credits to uniquely identify each of one or more carbon tonnage amounts associated with the one of the credits.

16. A system for facilitating the creation and sale of carbon credits, the system comprising at least one processor and memory configured to:
enroll a plurality of carbon credits in a database; and
for each credit, associate the credit with an account of a creator of the credit and with a carbon credit creation project for generating one or more environmental conditions for creating the credit;
the system further configured to receive, from at least one satellite, multi-spectral imagery of a location of one of the one or more projects, the at least one processor and memory further configured to:
use the imagery to evaluate one or more land characteristics at the location; and
use the one or more evaluated land characteristics to verify whether at least one of the credits is an actual credit.

17. The system of claim 16, wherein the at least one processor and memory are configured to:
analyze at least some of the imagery relative to an infrared spectral band;
overlay the imagery data with a geographic information system (GIS) data layer for a field zone associated with the location; and
verify whether the at least one of the credits is an actual credit based on the analysis and the overlay.

18. The system of claim 16, wherein the at least one processor and memory are configured to:
use the imagery to determine a quantity of biomass at the location; and
evaluate crop residue based on the determined biomass quantity.

19. The system of claim 16, wherein the at least one processor and memory are further configured to: determine whether one of the one or more projects is registered in a climate action registry; and
based on the determining, allow an aggregator to access, via a network and based on the project registration, data pertaining to at least one credit associated with the registered project.

20. The system of claim 16, wherein the at least one processor and memory are configured to serialize an actual credit to uniquely identify each of one or more carbon tonnage amounts associated with the actual credit.
